(19) United States
(12) Patent Application Publication
(10) Pub. No.: US 2025/0020950 A1
(43) Pub. Date: Jan. 16, 2025

(54) METASURFACE AND PHOTONIC DEVICE USING THE SAME

(71) Applicant: Bar Ilan University, Ramat Gan (IL)

(72) Inventors: Tomer LEWI, Tel Aviv (IL); Shany COHEN, Yokneam (IL)

(21) Appl. No.: 18/766,826

(22) Filed: Jul. 9, 2024

Related U.S. Application Data
(60) Provisional application No. 63/512,908, filed on Jul. 11, 2023.

(51) Int. Cl. G02F 1/01; B82Y 20/00; G02F 1/00

(52) U.S. Cl. CPC G02F 1/0147; B82Y 20/00; G02F 1/009; G02F 2202/10; G02F 2202/30; G02F 2203/15

(57) ABSTRACT

An optical element, as well as a metasurface formed by such optical elements, for use in photonic devices, are presented. The optical element is configured and operable as a sub-wavelength resonator having predetermined optical properties defining an optical response to incident light, wherein the optical element is configured as a metal-free multi-material structure of predetermined geometry and dimensions in which each two interfacing materials have positive and negative thermo-optic coefficients, respectively, such that the optical element has a near-zero effective thermo-optic coefficient, thereby providing substantial temperature invariance of said optical properties in predetermined wavelength and temperature ranges.

### CROSS-REFERENCE TO RELATED APPLICATIONS

The present application claims the priority benefit under 35 U.S.C. § 119 of U.S. Patent Application No. 63/512,908, filed on Jul. 11, 2023, the content of is are hereby incorporated in its entirety by reference.

### TECHNOLOGICAL FIELD

The present disclosure is in the field of photonic devices, in particular photonic devices with metasurfaces.

### BACKGROUND ART

References considered to be relevant as background to the presently disclosed subject matter are listed below:
1. G. P. Zograf, All Dielectric Thermonanophotonics, Adv. Opt. Photon 13, 1 (2021).
2. A. Archetti, R.-J. Lin, N. Restori, F. Kiani, T. v. Tsoulos, and G. Tagliabue, Thermally Reconfigurable Metalens, Nanophotonics 11, (2022).
3. A. Assadillayev, T. Hinamoto, M. Fujii, H. Sugimoto, and S. Raza, Thermal Near-Field Tuning of Silicon Mie Nanoparticles, Nanophotonics 10, 4161 (2021).
4. T. v. Tsoulos and G. Tagliabue, Self-Induced Thermo-Optical Effects in Silicon and Germanium Dielectric Nanoresonators, Nanophotonics 9, 3849 (2020).
5. T. Lewi, H. A. Evans, N. A. Butakov, and J. A. Schuller, Ultrawide Thermo-Optic Tuning of PbTe Meta-Atoms, Nano Lett 17, 3940 (2017).
6. T. Lewi, N. A. Butakov, and J. A. Schuller, Thermal Tuning Capabilities of Semiconductor Metasurface Resonators, Nanophotonics 8, 331 (2018).
7. M. Montesinos-Ballester et al., On-Chip Fourier-Transform Spectrometer Based on Spatial Heterodyning Tuned by Thermo-Optic Effect, Sci Rep 9, (2019).
8. K. Zangeneh Kamali, L. Xu, N. Gagrani, H. H. Tan, C. Jagadish, A. Miroshnichenko, D. Neshev, and M. Rahmani, Electrically Programmable Solid-State Metasurfaces via Flash Localised Heating, Light Sci Appl 12, (2023).
9. H. Yu and F. Qiu, Compact Thermo-Optic Modulator Based on a Titanium Dioxide Micro-Ring Resonator, Opt Lett 47, 2093 (2022).
10. B. S. Lee, M. Zhang, F. A. S. Barbosa, S. A. Miller, A. Mohanty, R. St-Gelais, and M. Lipson, On-Chip Thermo-Optic Tuning of Suspended Microresonators, Opt Express 25, 12109 (2017).
11. Y. Cao, E. Sahin, J. W. Choi, P. Xing, G. F. R. Chen, D. K. T. Ng, B. J. Eggleton, and D. T. H. Tan, Thermo-Optically Tunable Spectral Broadening in a Nonlinear Ultra-Silicon-Rich Nitride Bragg Grating, Photonics Res 9, 596 (2021).
12. S. Chung, M. Nakai, and H. Hashemi, Low-Power Thermo-Optic Silicon Modulator for Large-Scale Photonic Integrated Systems, Opt Express 27, 13430 (2019).
13. T. Tang and L. Luo, Refractive Index Sensor of Mach-Zehnder Interferometer Based on Thermo-Optic Effect of SOI Waveguide, Optik (Stuttg) 127, 6366 (2016).
14. M. Wang, D. J. Perez-Morelo, and V. Aksyuk, Overcoming Thermo-Optical Dynamics in Broadband Nanophotonic Sensing, Microsyst Nanoeng 7, (2021).
15. V. R. Anand, S. Mathew, B. Samuel, P. Radhakrishnan, and M. Kailasnath, Thermo-Optic Tuning of Whispering Gallery Mode Lasing from a Dye-Doped Hollow Polymer Optical Fiber, Opt Lett 42, 2926 (2017).
16. B. Sun et al., Broadband Thermo-Optic Switching Effect Based on Liquid Crystal Infiltrated Photonic Crystal Fibers, IEEE Photonics J 7, (2015).
17. X. Liu, P. Ying, X. Zhong, J. Xu, Y. Han, S. Yu, and X. Cai, Highly Efficient Thermo-Optic Tunable Micro-Ring Resonator Based on an LNOI Platform, Opt Lett 45, 6318 (2020).
18. M. Celebrano et al., Optical Tuning of Dielectric Nanoantennas for Thermo-Optically Reconfigurable Nonlinear Metasurfaces, Opt Lett 46, 2453 (2021).
19. D. Rocco et al., Opto-Thermally Controlled Beam Steering in Nonlinear All-Dielectric Metastructures, Opt Express 29, 37128 (2021).
20. D. Feng, G. R. Jaffe, S. Yin, G. R. Holdman, C. Wan, H. Mei, M. S. Jang, V. W. Brar, and M. A. Kats, Characterization of Temperature-Dependent Optical Properties of Materials for Metasurfaces in Extreme Conditions, in Proc. SPIE, Vol. PC12011 (2022), p. PC1201107.
21. G. R. Holdman, G. R. Jaffe, D. Feng, M. S. Jang, M. A. Kats, and V. W. Brar, Thermal Runaway of Silicon-Based Laser Sails, Adv Opt Mater 10, (2022).
22. A. Howes, J. R. Nolen, J. D. Caldwell, and J. Valentine, Near-Unity and Narrowband Thermal Emissivity in Balanced Dielectric Metasurfaces, Adv Opt Mater 8, (2020).
23. Y.-L. Tang, T.-H. Yen, K. Nishida, J. Takahara, T. Zhang, X. Li, K. Fujita, and S.-W. Chu, Mie-Enhanced Photothermal/Thermo-Optical Nonlinearity and Applications on All-Optical Switch and Super-Resolution Imaging [Invited], Opt Mater Express 11, 3608 (2021).
24. J. L. King, A. Shahsafi, Z. Zhang, C. Wan, Y. Xiao, C. Huang, Y. Sun, P. J. Roney, S. Ramanathan, and M. A. Kats, Wavelength-by-Wavelength Temperature-Independent Thermal Radiation Utilizing an Insulator-Metal Transition, ACS Photonics 9, 2742 (2022).
25. T. Stolberg-Rohr and G. J. Hawkins, Spectral Design of Temperature-Invariant Narrow Bandpass Filters for the Mid-Infrared, Opt Express 23, 580 (2015).
26. J. Rodrigues, G. Bhatt, I. Datta, U. Dave, S. Chaitanya, E.Shim and M. Lipson, SiN-Based Waveguides with Ultra-Low Thermo-Optic Effect; in Conference on Lasers and Electro-Optics, Technical Digest Series (Optica Publishing Group, 2022), paper SM4G.3., 2022.

Acknowledgement of the above references herein is not to be inferred as meaning that these are in any way relevant to the patentability of the presently disclosed subject matter.

### BACKGROUND

Thermal effects are well known to influence the electronic and optical properties of materials through several physical mechanisms and are the basis for various optoelectronic devices. The thermo-optic (TO) coefficient is a macroscopic property defining the refractive index variation with temperature (dn/dT), and is one of the most common mechanisms used for tunning [2-8], modulating [9-12], or sensing [13-19], where small changes in temperature lead to resonance wavelength shifts, variations in phase propagation, or other optical properties. Indeed, a plethora of active TO based devices have been successfully implemented in fiber-based devices [15,16], integrated optics [13,17], etc.

However, when a static and fixed operation is required, i.e., temperature invariant performance, this effect becomes a drawback and may lead to undesirable behavior through drifting of the resonance frequency, amplitude, or phase, as the operating temperature varies over time.

Temperature and thermodynamic effects in metasurfaces have been previously studied in space applications [20], laser science [21], thermal emission [20,22], photodetection, and imaging [23], where eliminating temperature effects in the performance of nanophotonics devices has been only studied in thin films and waveguides [24-26].

### GENERAL DESCRIPTION

There is a need in the art for a novel approach for eliminating or at least significantly reducing/mitigating temperature dependence of optical properties of a resonator structure, which may be a single-antenna resonator, meta-atom unit cell, and for a full metasurface structure.

While the TO effect offers significant advantages, it may pose a challenge when a consistent and constant optical response is necessary, as the optical characteristics of the device can vary with temperature, resulting in unfavorable performance. In high-Q resonant structures such as ring resonators with typical linewidth of ˜10 picometers, temperature changes as small as 0.1K will shift the operating resonance wavelength by 40 picometers [17] (i.e., 4 times the resonance linewidth), which would be detrimental to the device operation. Similar effects can also occur in low-Q resonant structures which are subjected to large temperature gradients (10s or 100s of kelvin degrees), where the optical properties may change dramatically. Extreme temperature gradients inherently exist in space applications, however, large and moderate temperature variations may also occur in laser systems, thermophotovoltaics, photodetection and sensing [14]. Temperature variations may be localized—due to, e.g., local heating from intense light sources [4] (due to small absorption arising from e.g., fabrication imperfections), electronic circuits, or non-local, due to changes in ambient temperature, as in the case for space applications or sensors.

Designing resonator structures with temperature invariance functionality is challenging and crucial for a variety of applications. Some of the techniques described in the literature deal with engineering temperature independent thermal emission and rely on insulator—metal transition in Mott insulators [24] and are thus limited to phase transition materials. Some other known techniques deal with spectral design of temperature invariant narrow bandpass filters using 1D thin film geometry [25]. The known techniques do not provide a solution for subwavelength Mie-resonators or metasurfaces, where complex wavefront control is required over several degrees of freedom. Moreover, these techniques suffer from limited temperature ranges—20-160° C. [25] or a range of 40° C. [24].

The present disclosure presents a systematic approach to mitigate thermally induced optical fluctuations in resonators and nanophotonic devices, particularly useful for photonic devices utilizing a metasurface (meta material) or a phased array antenna structure.

Metasurface is a nanopatterned structure of sub-wavelength thickness, i.e., a very thin optical element which is typically comprised of sub-wavelength structures (meta-elements) arranged in a plane. The optical characteristics of metasurfaces are derived from the material properties used to realize the device, as well as the size, geometry, morphology, and the arrangement of the meta-atom unit cells in the metasurfaces array. The performance of these devices are also effected by the excitation field and the ambient conditions (temperature). Metasurfaces allow for controlling the various degrees of freedom of light such frequency, phase, amplitude, polarization among other, at sub-wavelength scale.

The present disclosure provides a metal-free (non-metal) approach for configuring an optical element, as well as a metasurface structure formed by an array of such optical elements, with temperature invariant optical properties within a wide temperature range.

It should be noted that the optical element of the present disclosure is made of dielectric and/or semiconductor materials, and is referred to herein below as an all-dielectric element/structure.

It should also be noted that the term “optical properties” used herein, in relation to the optical element and metasurface made of such optical elements, relates to characteristics of optical response of the optical element to interaction with incident light, where optical response is expressed by transmission and/or scattering and/or reflection of the incident light affecting amplitude and/or phase and/or frequency and/or polarization, and/or spin angular momentum and/or orbital angular momentum of light resulting from such interaction. In the description below the optical properties are at times referred to as “scattering properties” or “spectral properties”, but it should be understood that the principles of the present disclosure are not limited to these specific properties and therefore these terms should be interpreted broadly as noted above.

The optical element is configured as a multi-material structure, in which each two interacting materials have thermo-optic (TO) coefficients of opposite signs, respectively, i.e., negative and positive TO coefficients exhibiting decrease and increase in refractive index, respectively, with an increase in temperature. The optical element (which may be of any suitable geometry which is properly optimized) presents a hybrid metal-free resonator defining at least one interface between materials with TO coefficients of opposite signs, i.e., negative and positive TO coefficients (dn/dT<0 and dn/dT>0).

For example, the optical element may be configured as a multi-layer structure (layers stack) formed by N layers (N>1) in which each two interfacing layers (layers Lᵢ-Lᵢ₊₁ and/or layers Lᵢ-Lᵢ₋₁) are made of the materials having, respectively, negative and positive TO coefficients.

It should further be noted that the technique of the present disclosure provides temperature invariance of the optical element within a spectral range for which the optical element is to be used, for a wide temperature range. Such wide temperature range may be from 0K up to the temperature close to the lowest melting point and/or phase transition of the given material of the optical element and/or any temperature where the material properties are no longer adequate to support the required optical response.

The metasurface structure of the present disclosure is a non-metal structure comprising an array of discrete unit cells, each unit cell being configured as the above described optical elements, i.e., a multi-material element/structure (e.g., multi-layer structure) in which each two interfacing materials have negative and positive TO coefficients, respectively. The size, geometry, and possibly also orientation of the unit cells as well as distances between the unit cells, are properly optimized to maintain the desired optical properties of the metasurface while providing temperature invariance thereof. It should be understood that the optical properties of the metasurface may also include a spatial gradient profile (beam shaping, beam focusing, etc.) where the unit cells have spatially varying sizes, orientation etc., in order for the metasurface to perform according to the desired functionality (beam shaping, beam focusing, etc.).

Optimization of the geometrical parameters (dimensions and shape) of the optical element/unit cell (and possibly also orientation and/or relative accommodation of the unit cells) for given materials of the unit cell(s) is aimed at providing a substantial overlap of the scattering properties of the unit cell (and the entire metasurface) within a predetermined wavelength range, and within the predetermined temperature range.

Some examples of positive TO coefficient materials include: silica (SiO2), i.e., fused silica and other forms of silica glass (typically used in fiber optics and other optical devices); fluoride glasses in infrared optics and fiber optics; some semiconductor materials, particularly in their crystalline form, e.g., silicon and germanium; certain types of liquid crystals (typically, those used in display technologies and adaptive optics); certain polymers.

Some examples of negative TO coefficient materials include: certain polymers, certain types of glasses (such as TiO₂) and crystals; some semiconductors (e.g., chalcogenide material family such as PbSe, PbS and PbTe) depending on their composition and doping levels.

The inventors have shown that by using hybrid subwavelength resonators composed from at least one pair of interfacing layers made of materials having opposite TO dispersions (dn/dT<0 and dn/dT>0), and optimizing the resonator geometrical parameters and TO dispersions (the TO coefficient dependence on wavelength of interacting light), compensation for TO shifts can be obtained enabling to provide nanophotonic components with zero effective TO coefficient (dn_{eff}/dT≈0). The inventors have demonstrated temperature invariant resonant frequency, amplitude, and phase response in meta-atoms and metasurfaces operating across a wide temperature range and broad spectral band.

The temperature independent metasurface structure of the present disclosure is designed to manipulate the wavefronts of light beams by confining light in antenna arrays of three-dimensional (3D) subwavelength resonators. It should be noted that this approach is very different to waveguide-based structures (addressed in the literature) where light is guided by total internal reflection through the core of the waveguide and propagates thousands of wavelengths long before emerging at the output, or in 1D thin film filter geometry.

The technique of the present disclosure allows to engineer the metasurface structure having temperature invariant properties such as: resonance frequency, amplitude and phase responses (generally, any property of light such as polarization, spin, angular momentum etc.), within a wide range of temperatures (up to 500K) and across a large spectral band.

Thus, according to a broad aspect of the present disclosure, it provides an optical element for use in a photonic device, the optical element being configured and operable as a subwavelength resonator structure having predetermined optical properties defining an optical response to incident light, wherein the optical element is configured as a metal-free multi-material structure of predetermined geometry and dimensions in which each two interfacing materials have positive and negative thermo-optic coefficients, respectively, such that the optical element has a near-zero effective thermo-optic coefficient, thereby providing substantial temperature invariance of said optical properties in a predetermined wavelength and temperature ranges.

According to another broad aspect of the present disclosure, a metasurface structure for a photonic device is provided, wherein the metasurface structure comprises:
an array of spaced-apart individual unit cells operable as subwavelength resonators, wherein each of the unit cells is configured as a metal-free multi-material structure of predetermined geometry and dimensions in which each two interfacing materials have positive and negative thermo-optic coefficients, such that the unit cell has a near-zero effective thermo-optic coefficient, thereby providing substantial temperature invariance of optical properties of the unit cell and the metasurface structure in a predetermined wavelength and temperature ranges.

As described above, a temperature range of the near-zero effective thermo-optic coefficient is from 0K up to a temperature corresponding to at least one of the following: a lowest melting temperature of the material of at least one of said two interfacing materials; lowest temperature of phase transition of the at least one of said two interfacing materials; a lowest temperature at which material properties of at least one of said two interfacing materials are no longer capable of supporting the optical response.

The geometry and dimensions of the multi-material structure are selected such that scattering properties of the optical element within the predetermined wavelength range substantially overlap.

In some embodiments, the negative thermo-optic coefficient material of the two interfacing materials is a material from a lead chalcogenide family PbX, wherein X is any one of the following: Te, Se, S.

In some embodiments, the optical element is configured as a multi-layer structure, in which each two interfacing layers are made of the materials having, respectively, negative and positive TO coefficients, and properly optimized geometrical parameters (geometry/shape and dimensions).

In some embodiments, the optical element is configured as a core-shell spherical Mie resonator. For example, this is a three-layer core-shell Si/PbTe/Si spherical structure. For example, in such three-layer structure, a thickness of a PbTe inner shell is selected (optimized for given geometrical parameters of the Si layers) to provide substantial overlap of scattering properties of the resonator within said predetermined wavelength and temperature ranges. The predetermined temperature range may for example be about 143K-643K.

In some embodiments, the optical element is configured as a cubic resonator. The predetermined dimensions comprise a side length of a cube and a thickness of each material of the multi-material structure of the cubic resonator (e.g., a height of each of layers of the multi-layer structure of the cubic resonator). For example, the cubic resonator is configured as a cubic three-layer hybrid resonator comprising bottom and top layers made of Si, and a middle layer made of PbTe.

In some embodiments, the optical element is configured as a disk resonator. The predetermined dimensions comprise a disk diameter and a thickness of each material of the multi-material structure of the disk resonator (e.g., a height of each of layers of the multi-layer structure of the disk resonator). For example, the disk resonator is configured as a disk three-layer hybrid resonator comprising bottom and top layers made of Si, and a middle layer made of PbTe.

As noted above, the temperature invariant optical properties comprise one or more of the following characteristics of light resulting from interaction with the incident light: wavelength of Mie resonant mode, cross section, amplitude, phase response, polarization, angular momentum, orbital angular momentum.

The optical elements may be configured for transmission of incident light, and/or reflection or scattering of incident light.

Considering the metasurface structure formed by an array of the above-described optical elements (unit cells), the unit cells may be arranged in M sets (M≥2) of similar arrangements, where each set is formed by K unit cells (K≥2), wherein the unit cells of the set are similar or different in at least one of geometry, dimensions and orientation of the unit cell.

The results presented in the present disclosure highlight a path towards temperature invariant nanophotonics, which can provide constant and stable optical response across a wide range of temperatures and be applied to a plethora of optoelectronic devices. Controlling the sign and magnitude of TO dispersion extends the capabilities of light manipulation and adds another layer to the toolbox of optical engineering in nanophotonic systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1 schematically illustrates a photonic device including a temperature invariant metasurface structure of the present disclosure;

FIG. 2 exemplifies a hybrid unit cell (resonator) of the present disclosure suitable for use in the metasurface structure;

FIG. 3 exemplifies thermo-optic induced shifts in conventional-type metasurfaces, showing the metasurface comprised of silicon disks, on BaF₂ substrate, exhibiting significant resonance red shift (Δλ≈137 nm) with temperature, for the unit-cell disk dimensions of d (diameter)=1 μm, h (height)=2.25 μm, the periodicity Λ=3.2 μm;

FIG. 4 exemplifies the principles of designing temperature invariant nanophotonic components, showing the hybrid meta-atoms composed from two materials with opposite sign TO coefficients, exhibiting temperature invariant response, including Si as positive TO material (dn/dT>0) and PbTe as negative TO material (dn/dT<0), exhibiting temperature invariant performance manifested by spectral overlap for two extreme temperatures;

FIGS. 5A to 5E illustrate configuration and properties of temperature invariant multilayer Si/PbTe/Si spherical resonators, where FIG. 5A shows optimization of the Si/PbTe/Si structure, FIG. 5B shows quantitative color map of the same optimization process, FIG. 5C shows comparison between the scattering spectra of the optimized hybrid structure (red) and the spectra of an uncompensated Si sphere (blue) of the same size, for the two extreme temperatures (T_{L}=143K and T_{H}=643K), FIG. 5D shows scattering spectra of the optimized multilayer spherical resonator, demonstrating fixed spectral position across a ΔT=500K temperature swing for increments of 50K (the spectra are vertically shifted along the y-axis for visibility), and FIG. 5E shows transmission amplitude and phase spectra at T=143K and T=643K, respectively, calculated for the hybrid unit-cell using periodic boundary conditions along x-y plane;

FIG. 6 illustrates extracted resonance wavelength vs. temperature for MD (blue), ED (red) and MQ (green) resonances in spherical resonators of FIG. 5C;

FIGS. 7A and 7B illustrate electric and magnetic field profiles along the xy and yz planes for the first two fundamental resonances, calculated at the lowest (143K) and highest (643K) temperatures for the hybrid sphere presented in FIGS. 5A-5E with the 3-layer hybrid sphere dimensions of r_{Si}=0.43 μm, r_{PbTe}=0.62 μm and the outer Si radius of r_{Si}=1.2 μm, where FIG. 7A shows fundamental MD resonance at λ≅9.25 μm, FIG. 7B shows ED resonance at λ≅7.22 μm;

FIGS. 8A-8D exemplify disk and cubic multilayer hybrid resonators, where FIG. 8A shows scattering spectra of a cubic resonator having dimensions of h_{Si,1}=0.92 μm, h_{PbTe}=0.34 μm and h_{Si,2}=0.92 μm, and the side of a=1 μm, FIG. 8B shows reflection amplitude and phase for T=143K (blue) and T=643K (orange), exhibiting minor variations in both the phase and amplitude for the two extreme temperatures, FIG. 8C shows hybrid disk scattering spectra, demonstrating temperature independent behavior for the second mode (dashed circle), and FIG. 8D shows transmission amplitude and phase around the second (ED) mode;

FIGS. 9A and 9B illustrate spectra of uncompensated TO structures of uniform Si for cubic and disk geometries, respectively;

FIG. 10A illustrates electric and magnetic field patterns (xz plane) of the cubic resonator at the first resonance λ=5.86 μm, for the cubic geometry of: h_{Si}=0.92 μm, h_{PbTe}=0.34 μm, while the length and width at the x-y plane are 1 μm each;

FIG. 10B illustrates electric and magnetic field patterns (xz plane) of the disk resonator at the second resonance λ=4.71 μm for the disk geometry of h_{Si}=0.96 μm, h_{PbTe}=0.24 μm, r=0.5 μm;

FIGS. 11A and 11B illustrate extracted resonance wavelength vs. temperature for fundamental mode in the cubic resonator (FIG. 11A) and the 2^{nd} mode of the disk resonator (FIG. 11B); and

FIG. 12 illustrates schematically a metasurface structure used in simulations conducted by the inventors;

FIGS. 13A to 13C illustrate hybrid disk metasurface reflection spectra demonstrating near perfect temperature invariant behavior (FIG. 13A), hybrid disk metasurface reflection spectrum, demonstrating pinned behavior of the amplitude and phase of T=143K vs. T=643K (FIG. 13B), and extracted resonance wavelength vs. temperature for the Fundamental (blue, upper panel) and the 2^{nd} (red, lower panel) modes of the hybrid disk metasurface (FIG. 13C).

### DETAILED DESCRIPTION OF EMBODIMENTS

The present invention provides a novel configuration of an optical resonator for use in a phonic device, i.e., optical element having certain optical properties defining its response to interaction with incident light, which according to the present disclosure is characterized by its substantial temperature invariance within a wide range of temperature conditions. Such optical element/resonator is termed here “unit cell” and may present a single resonator, meta-atom unit cell, or can form an element of multi-resonator metasurface structure (i.e., “pixel” in the array/matrix of elements of the metasurface).

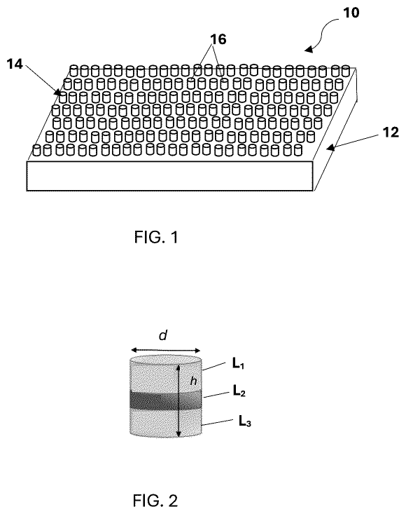

Referring to FIG. 1, there is schematically illustrated a photonic device 10 of the present disclosure. The device 10 has a substrate structure 12 (which may include/carry various electronic utilities of the device) and has a metasurface structure 14. The metasurface structure 14 is configured according to the present disclosure such that it is substantially temperature invariant within a wide wavelength range and within a wide temperature range, i.e., from 0K up to the temperature close to the lowest melting point and/or phase transition of the given material of the optical element, and/or any temperature where the material properties are no longer adequate to support the required optical response.

In the specific non-limiting examples presented below, the temperature invariance of the structures of the present disclosure within the temperature range up to 500K is demonstrated.

The metasurface structure 14 comprises an array/matrix of (discrete) unit cells 16 each configured with the temperature invariance property. The unit cells may be arranged in a constant or varying spaced-apart relationship and operable as subwavelength resonators.

Generally, the unit cells 16 are arranged in M groups/sets (M≥1) of similar configurations, where each group/set is formed by K unit cells (K≥2), depending on the intended functionality of the photonic device. In case of multi-group configuration (M≥2), the unit cells of the group may be different in dimensions and/or orientation of the unit cells and/or distances between the unit cells of the group. For example, the unit cells are arranged in a supercell repeating structure, such that groups/sets, each formed by e.g. 2-10 different unit cells e.g. differently spaced between them, are repeated in the whole metasurfaces.

For example for the metasurface configured to operate as a lens (metalens), the unit cells have varying lateral dimension (diameters) and/or orientation to provide beam shaping of the lensing effect (wavefront of light).

As shown more specifically in FIG. 2, the unit cell 16 is configured as a multi-material all-dielectric (metal-free) structure of predetermined geometry and dimensions. In this specific non-limiting example, the unit cell 16 is illustrated as a multi-layer structure (layer stack), but it should be understood that the principles of the present disclosure are not limited to this configuration. Also, although in this specific not limiting example the unit cell has a cylindrical configuration and includes three dielectric and/or semiconductor materials/layers L₁, L₂, L₃, the principles of the present disclosure are not limited to any specific geometry (shape and dimensions), morphology or orientation of the unit cell, and not limited to any specific number of material/layers and their thicknesses.

The unit cells 16 may be of any suitable configuration, which, as will be described further below, is optimized to provide temperature invariance of the optical properties of the unit cells and the metasurface structure 14 formed by the arrangement/array of such unit cells 16. The multi-material configuration of the unit cell 16 is such that each two interfacing materials have thermo-optic coefficient of opposite signs, such that the unit cell (and the metasurface structure) has a near-zero effective thermo-optic coefficient, thereby providing temperature invariant optical properties of the metasurface structure in predetermined wavelength and temperature ranges.

In the non-limiting example of FIG. 2, the unit cell 16 has two such interfacing pairs of materials (e.g., layers), i.e. L₁-L₂ and L₂-L₃.

Generally, the unit cell 16 is configured as a hybrid resonator having temperature invariant performance manifested by constant optical properties (e.g., overlap of the scattering spectra, the scattering phase, amplitude etc.) within the temperature invariance range for which the resonator is designed.

The thermo-optic (TO) coefficient is a macroscopic property defining the refractive index variation with temperature (dn/dT) and can be assigned to materials, composites, and devices. As described above, many optoelectronic applications utilize this effect as tuning, modulating, or sensing mechanism, where small changes in temperature lead to resonance wavelength shifts, variations in phase propagation, or other optical properties. However, many applications require a consistent and constant optical response of the photonic device, and thus variation of the optical characteristics of the device with temperature should be avoided, to maintain the device performance.

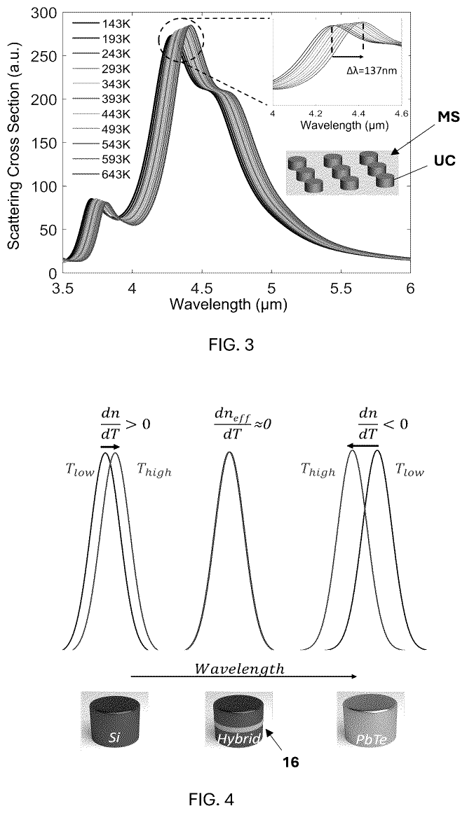

Let us consider, for example, the temperature dependent mid-infrared (MIR) spectra of a silicon disk metasurface. In this connection, reference is made to FIG. 3 wavelength dependent scattering properties of a conventional-type metasurface MS comprised of unit cells UC in the form of silicon disks arranged on BaF₂ substrate, plotted for the temperature range 143-643K. In this example, the unit-cell disk dimensions are d (diameter) of 1 μm, h (height) of 2.25 μm, the periodicity Λ of 3.2 μm. The figure shows thermo-optic induced shifts in the metasurface MS. The silicon disks exhibit significant resonance red shift (Δλ≈137 nm) with temperature. The spectra exhibit strong temperature dependent resonance red shifts (Δλ≈140 nm, 0.3 nm/K) which ultimately result in significant changes in all optical properties (i.e., amplitude, phase). Such strong temperature dependance is a result of the large TO coefficient of silicon (dn_{Si}/dT˜2.5 10⁻⁴/⁰K [5]) and cannot be ignored when the device is subjected to large temperature variations (as shown in the figure).

The effect of thermo-optically induced shifts becomes increasingly significant for high-Q structures, and particularly in ultra-high Q resonant structures such as microring, microsphere and microtoroid resonators. Even small temperature variations in the range of fractions of a kelvin degree can have a detrimental impact on the performance of these devices.

Reference is now made to FIG. 4 exemplifying the principles underlying the systematic approach for temperature invariant metasurfaces of the present disclosure. This approach is based on hybrid all-dielectric (metal-free) resonators 16 composed from two or more materials defining at least one pair of interfacing materials (e.g., layers) with opposite sign TO coefficients (dn/dT<0 and dn/dT>0).

FIG. 4 shows specific not limiting example of the unit cell in the form of hybrid meta-atoms composed from two materials with opposite sign TO coefficients, i.e., two interfacing materials of positive and genitive TO coefficients, respectively, exhibiting temperature invariant response.

In some specific not limiting examples, the positive TO material may be Si (dn/dT>0) and the negative TO material (dn/dT<0) may be PbTe.

The hybrid resonators 16 configured as described above (for example but not limited to Si/PbTe/Si resonator) can be configured to exhibit temperature invariant performance expressed by spectral overlap (e.g., of the scattering cross section spectra) for the desired temperature range as described above. By optimizing the resonator geometrical parameters and TO dispersions, TO shifts can be compensated and meta-atoms and metasurfaces with zero effective TO coefficient (dn_{eff}/dT≈0) can be obtained.

As described above, the present disclosure provides the metasurface formed by all-dielectric unit cell structures characterized by their high efficiency, as they avoid the ohmic losses that are inherently introduced by metals, or plasmonic materials in general.

It should be noted that, generally, metals could be used. However, TO effects in these materials are different. While in semiconductors, the TO effect is mainly determined by variations of the bandgap energy with temperature, the optical constants and TO effects in metals are primarily determined by the properties of their free electrons. Increasing the temperature in metals will alter their complex permittivity which will be manifested in most cases by increased ohmic losses, resonance broadening, and amplitude damping caused by stronger electron-phonon scattering. Hence, eliminating thermo-optical effects in metal-dielectric or all metallic structures is difficult, especially for large temperature gradients.

The present disclosure provides all-dielectric approach for a variety of typical nanophotonic components, including Bragg mirrors, single spherical, cubic and disk resonators and also for large metasurface arrays. The inventors' findings demonstrate that by controlling the sign and magnitude of TO dispersion, it is possible to cancel or mitigate thermally induced shifts in optical systems, leading to increased stability, efficiency, and performance. This approach provides for controlling light response of the device and can thus be implemented in various nanophotonic systems.

The inventors have demonstrated the temperature invariance functionality in 1D Bragg mirrors, single Mie resonators of various geometries, and full metasurfaces. In the experiments and simulations conducted by the inventors, for the positive TO material, Silicon was used, being a high index material (nSi≈3.42@5 μm and dnSi/dT=2.5 [10⁻⁴/K] at room temperature) which is transparent across the infrared range [4]. To compensate for the positive TO effect in silicon, the unit cell includes material(s) with negative TO coefficients in the layer(s) interfacing with the silicon-material layer. While most high index dielectrics and semiconductors possess positive TO coefficients, the lead chalcogenide family (PbTe, PbSe, PbS) has both high refractive indices and an anomalous negative TO effect. PbTe was selected as the negative TO material, as it has the highest refractive index (nPbTe=5.85@5 μm) and largest TO coefficient (dnPbTe/dT=−13.5[10⁻⁴/K] at RT) among the lead chalcogenides [5]. These two materials, Silicon and PbTe, form the basic hybrid unit cell in the experimental metasurface structure. It should, however, be understood that the principles of the present disclosure are not limited to any specific materials, provided they are non-metal materials and each two interfacing materials have, respectively, positive and negative TO coefficients.

In this connection, the following should be noted. The thermo-optic (TO) effect describes the variation of the refractive index with temperature, and can be defined in the transparent regime as:

$$2 n \frac{dn}{d T} = ( {n}_{∞}^{2} - 1 ) ( - 3 α R - \frac{1}{{E}_{eg}} \frac{{dE}_{g}}{dT} {R}^{2} ) \qquad ( 1 )$$

where n, n∞ and T are the refractive index, the high frequency refractive index and temperature respectively, aα is the linear thermal expansion coefficient,

$$R = \frac{{λ}^{2}}{{λ}^{2} - {λ}_{ig}^{2}}$$

where λ_{ig} is the wavelength corresponding to the temperature-invariant isentropic bandgap, and E_{eg} is the temperature-dependent excitonic bandgap.

According to the relation in Eq (1), the TO coefficient encapsulates contributions from several physical mechanisms such as thermal expansion, excitonic and phonon excitations. For semiconductors and dielectrics, operating in the normal spectral regime (for λ>λ_{ig} and therefore R>0), the dominant contributor is the excitonic bandgap, typically by two orders of magnitude (α is typically ˜10⁻⁶/° K while dE_{eg}/dT˜10⁻⁴eV/° K). For vast majority of semiconductors (including Silicon), the excitonic bandgap decreases with temperature

$$( \frac{{dE}_{Eg}}{dT} < 0 )$$

and since it is multiplied by another negative term (−1/E_{eg}), it follows that the TO coefficient is usually positive. It appears that the lead chalcogenide family PbX (X=Te, Se, S) exhibit an anomalous bandgap energy dispersion with temperature dE_{g}/dT>0 and hence also a similar behavior for the excitonic bandgap dispersion dE_{eg}/dT>0, i.e., the bandgap increases when temperature increases [1] and hence the refractive index in lead chalcogenides decreases with temperature, in contrast to most materials. This anomalous negative TO coefficient in PbTe is the enabling component for the TO dispersion engineering used by the inventors.

The inventors used the wavelength and temperature dependent TO coefficients where dn_{Si}/dT=2.5[10⁻⁴/⁰K], dn_{PbTe}/dT−13.5[10⁻⁴/⁰K] are typical values in the transparent region. The chromatic dispersion of Si at room temperature (RT) and the dispersion relation of PbTe is given by:

$${n}_{PbTe} ( λ ) = \sqrt{1 + \frac{30.586 {λ}^{2}}{{λ}^{2} - 2.0494} - 0.0034832 {λ}^{2}} \qquad ( 2 )$$

When calculating thermal and TO effects, the inventors assumed materials and components have reached equilibrium and did not consider any transient effects. Also, no nonlinear effects were considered. For PbTe, the inventors used the TO coefficient at room temperature.

When designing the unit cell configuration, the chromatic dispersion (n(λ)) of the refractive indices of both materials, as well as, the temperature and wavelength dispersion of the TO coefficients dn/dT(λ,T) were considered. While there are several experimental reports for the temperature dependance of the TO coefficient in Si, spanning hundreds of kelvin degrees, this is not the case for PbTe. In fact, the dn/dT of PbTe was mostly measured around room temperature. Therefore, the inventors used the reported room temperature value of dn/dT(λ) in crystalline PbTe, for all the range of calculated temperatures. It should be noted that accurate knowledge of the TO coefficients across a large range of temperatures determines the performance of temperature invariant devices.

The spectral range of interest in the experiment conducted by the inventors lies in the mutual transparent infrared range of both materials (3.8 μm<λ<15.5 μm), away from the fundamental materials bandgaps (λg˜1.1 μm for Si and λg˜3.8 μm for PbTe, where λg is the wavelength corresponding to the energy bandgap). The bandgap wavelength λg˜3.8 μm of PbTe is the lower limit where it can be considered transparent. For shorter wavelengths, PbTe will start absorbing and its refractive index will become complex, resulting in resonance broadening and amplitude damping, which will ultimately affect the ability to compensate for the TO effects in silicon. The long wavelength limit is determined by multiphonon absorption in Si, typically around ˜15.5 μm, leading to the transparency spectral range 3.8 μm<λ<15.5 μm of the hybrid structures presented here.

### 2D Structures: Three-Layer Hybrid Mie Resonators

Mie-resonant nanostructures are known as exhibiting similar properties to plasmonic structures such as enhanced scattering and also possessing unique properties, including strong magnetic resonance, which benefit applications including dielectric nanoantenna and unidirectional scattering metasurfaces.

The power in manipulating free space light lies in two-dimensional metastructures. Mie resonator meta-atoms form the basic unit cell building blocks for metasurfaces and metamaterials and are also excellent scatterers as single or ensembles of nano-antennas.

The inventors started by designing temperature invariant three-layer hybrid single Mie-resonators spanning various geometries. The inventors selected three common geometries—sphere, disk, and cubic resonators, and carefully engineered each of the structures to eliminate the TO dispersion (dneff/dT≈0) for a given mode. The structures are symmetric in the x-y plane, and the incident beam is x-polarized propagating along the z-axis. The unit cell in all structures is composed of three Si/PbTe/Si layers and the scattering spectra were obtained using finite difference time domain (FDTD) solver.

FDTD calculations were performed using the Lumerical Solutions FDTD solver, Version 8.25.2647. New materials with the required dispersion data were imported to Lumerical data set. The excitation source in all cases is a plane wave. Initially calculations were performed for a single isolated (Mie/cubic/disk) resonator and only then for a full metasurface formed by arrangement of such resonators.

It should be noted that the above-described three-layer (or generally, multi-material) Mie-resonator structures can be fabricated using standard top-down or bottom-up fabrication techniques.

### Spherical Multi-Material Core-Shell Hybrid Mie-Resonators

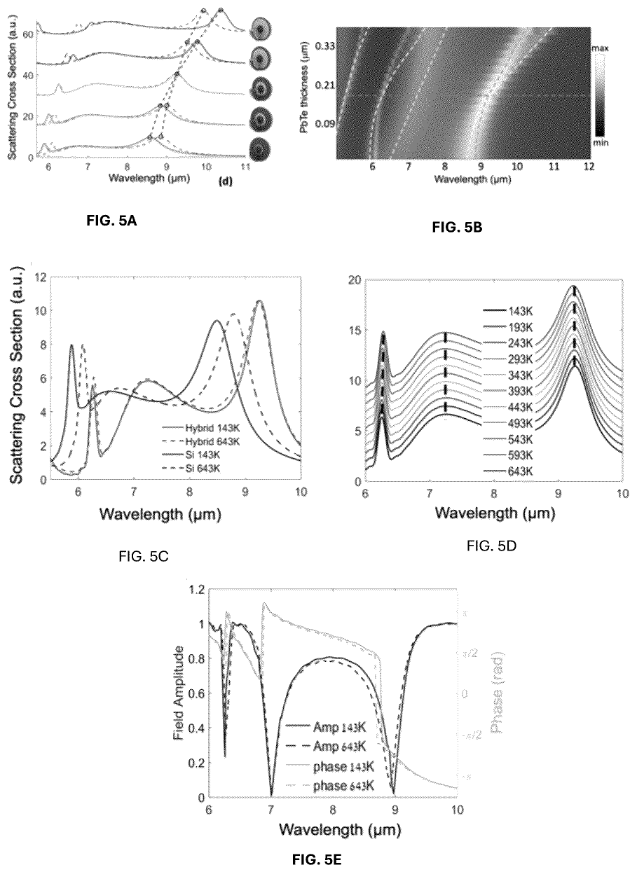

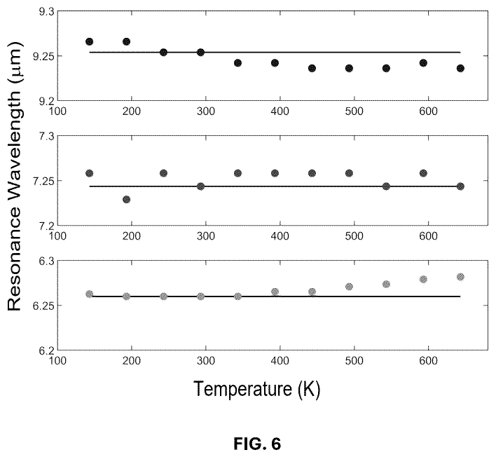

In this connection, reference is made to FIGS. 5A-5E exemplifying configuration and properties of temperature invariant multi-material Si/PbTe/Si spherical resonators. Here, FIG. 5A shows optimization of the Si/PbTe/Si structure by plotting the spectra for the two extreme temperatures T_{L}=143K (solid lines) and T_{H}=643K (dashed lines), varying the PbTe shell thickness (spectra are vertically shifted for visibility), while keeping the inner (core) Si diameter (d_{Si.1}=0.86 μm) and the overall diameter of the structure fixed (dₜₒₜ=2.4 μm). The dashed black lines follow the spectral position of the fundamental MD mode. Optimum thickness is reached when the two spectra completely overlap, resulting in temperature invariant response. FIG. 5B shows quantitative color map of the same optimization process. The spectra for the two extreme temperatures are plotted together, while varying the PbTe thickness. The color represents the scattering intensity at each point in the map. The dashed white and light blue lines follow the spectral evolution of the first four Mie-resonant modes for the low temperature T_{L}=143K (white), and high temperature T_{H}=643K (light blue), for varying PbTe shell thickness. The horizontal dashed line corresponds to the crossing point of the two branches (T_{L} and T_{H}), representing the optimized PbTe thickness for temperature invariant response. FIG. 5C shows comparison between the scattering spectra of the optimized hybrid structure (red) and the spectra of an uncompensated Si sphere (blue) of the same size, for the two extreme temperatures (T_{L}=143K and T_{H}=643K). For the optimized hybrid spherical resonator the inner Si radius is r_{Si}=0.43 μm, the PbTe radius is r_{PbTe}=0.62 μm and the outer Si layer radius is r_{Si}=1.2 μm. FIG. 5D shows scattering spectra of the optimized multi-material spherical resonator, demonstrating fixed spectral position across a ΔT=500K temperature swing for increments of 50K (the spectra are vertically shifted along the y-axis for visibility). FIG. 5E shows transmission amplitude and phase spectra at T=143K and T=643K, respectively, calculated for the hybrid unit-cell using periodic boundary conditions along x-y plane (as described above). Negligible variations in both amplitude and phase are observed, demonstrating that in addition to resonant frequency, both the phase and the amplitude remain the same between these two extreme temperatures (143K vs. 643K).

FIG. 5A shows the spectra of multi-material core-shell Si/PbTe/Si spherical Mie resonators and illustrates the design and optimization of the structure for obtaining temperature invariant response (the multi-material (multi-layer) structures are shown in the inset, red colors represent the Si core and outer shell, gray is the PbTe inner shell). In this example, it was done through sweeping the inner PbTe shell thickness, while keeping the inner (core) Si diameter (dSi,1=0.86 μm) and the overall diameter of the structure fixed (dtot=2.4 μm). This figure presents the scattering spectra for the two extreme temperatures TL=143K (solid lines) and TH=643K (dashed lines), varying the PbTe shell thickness (the spectra are shifted vertically for visibility). The goal of the optimization process is to increase the thickness of the PbTe layer in the compound, until the spectra at the two extreme temperatures TL=143K (solid lines) and TH=643K, will completely overlap. The increase in the PbTe shell thickness results in two effects. First, the total effective index of the structure increases (due to the larger fraction of the high index PbTe in the compound), resulting in a red shift of the spectra for both temperatures. This explains the spectral red shift for both temperatures (solid lines and dashed lines) as we move up in the plot for structures with larger PbTe volume. Second, as the PbTe thickness increases, the effective TO coefficient (dneff/dT) in the multilayer structure decreases, reducing the relative shift between the spectra of the two extreme temperatures. The optimum thickness is reached when the two spectra completely overlap, resulting in temperature invariant response. Further increasing the thickness of the PbTe beyond the optimum point, results in splitting of the two spectra once more.

FIG. 5B presents a quantitative color map of this same process, where the spectra for the two extreme temperatures (TL=143K and TH=643K) are plotted together, for varying PbTe thicknesses (the color represents the scattering intensity). The dashed lines follow the spectral mode evolution of the first four Mie-resonant modes, for TL=143K (white) and TH=643K (light blue), for varying PbTe shell thicknesses. The horizontal gray dashed line corresponds to the crossing point of the two branches (TL and TH) of each Mie mode, representing the optimized PbTe thickness for temperature invariant response.

FIG. 5C compares the scattering spectra of the optimized hybrid structure, to the spectra of a Si sphere of the same diameter, for the two extreme temperatures (TL=143K and TH=643K). While the Si sphere exhibits TO shift of ˜300 nm for the ΔT=500K temperature difference, the hybrid sphere presents overlapping spectra with temperature independent resonance wavelength positions.

FIG. 5D presents the optimized hybrid sphere spectra varying the temperature in increments of 50K (the spectra are vertically shifted along the y-axis for visibility). It is clear that the optimization procedure resulted in temperature invariant response for all the temperatures within the studied range. Namely, the spectral position of the first three resonant modes: the magnetic dipole (MD), electric dipole (ED), and magnetic quadrupole (MQ), are fixed.

In addition to the spectral response, both the phase and the amplitude remain the same, as presented in FIG. 5E. This is exemplified by the overlapping amplitude and phase response across the 6-10 μm spectral range, at 143K and 643K, respectively.

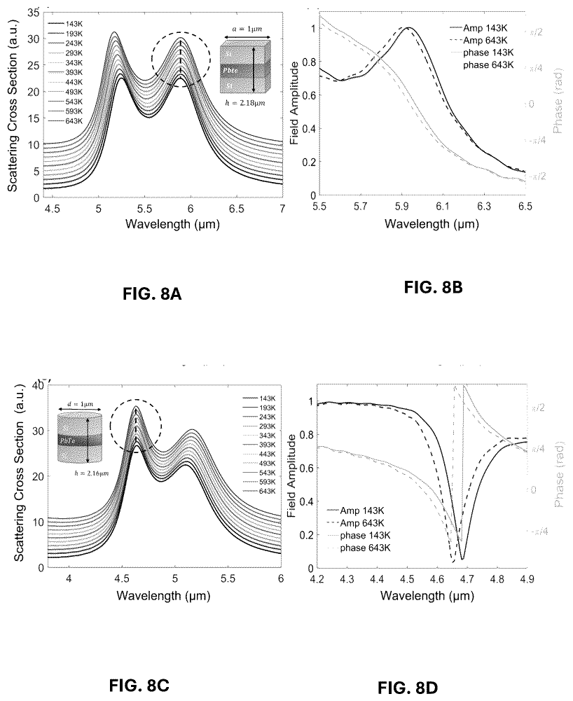

To quantify the resonance wavelength shifts, the inventors defined a normalized figure of merit (FOM) Smax=Δλ/λ₀ where λ₀ is the resonance wavelength at room temperature, and Δλ is the maximum resonance shift compared to the resonance wavelength at room temperature. FIG. 8 presents the extracted temperature dependent resonance wavelengths of the MD (blue), ED (red) and MQ (green) modes-resonances in spherical resonators shown in FIG. 5D. Evidently, temperature independent response is manifested by a small FOM of all resonances (|Smax|<0.003) for this spherical resonator.

Complete cancelation of the effective TO effect in the resonator (dneff/dT=0) is limited to ˜ΔT=150K. For example, the MQ mode (green dots, lower panel of FIG. 6), was optimized to exhibit zero resonance wavelength shift dλ/dT=0 for 193K<T<343K. For comparison, with no TO correction, a similar sized silicon resonator would have exhibited a Δλ=75 nm resonance wavelength shift for the same ΔT=150K.

Furthermore, analysis of the temperature dependent electric and magnetic field distributions for all the resonances reveals that the resonant mode field profiles also remain fixed across the full 500K temperature gradients.

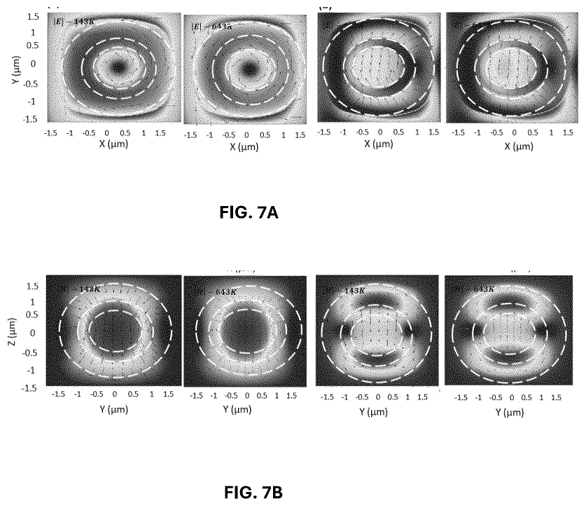

In this connection reference is made to FIGS. 7A and 7B showing field distributions (electric and magnetic field profiles along the xy and yz planes) for the first two fundamental resonances, calculated at the lowest (143K) and highest (643K) temperatures for the hybrid sphere presented in FIGS. 5A-5E. The 3-layer hybrid sphere dimensions are r_{Si}=0.43 μm, r_{PbTe}=0.62 μm and the outer Si radius is r_{Si}=1.2 μm. FIG. 7A shows fundamental magnetic dipole (MD) resonance (first resonance) at λ≅9.25 μm, showing a clear distribution of the MD mode, and FIG. 7B shows electric dipole (ED) resonance (second resonance) at λ≅7.22 μm. It should be noted, however, that the field pattern is more complex compared to a single sphere, due to the additional shell layers. Interestingly, field profiles of both modes seem almost identical in the two extreme temperature values 143K and 643K.

### Hybrid Disk and Cubic Mie-Resonators

Disk and cubic resonators are the most common unit-cells in meta-optics and possess additional degrees of freedom compared to spheres, as their geometry breaks the spherical symmetry. The FDTD scattering spectra, along with the amplitude and phase response of cubic and disk hybrid Mie-resonators are shown in FIGS. 8A-8D. The breaking of spherical symmetry, especially along the z axis compared to the x-y plane, is known to change the dispersion of different Mie resonant modes and is often used to design unidirectional Huygens metasurfaces. Here, the different polarization of Mie-resonances leads to different temperature dispersion of resonances which makes it more challenging to simultaneously design temperature invariant response for two or more resonant modes. Hence, the inventors considered temperature invariant response around one resonance mode per structure, where canceling the TO dispersion in each structure is optimized for one dipolar mode.

The spectra presented in FIGS. 8A and 8C, demonstrate minor wavelength variations over large temperature span (ΔT=500K), for a particular dipolar mode of the individual resonator.

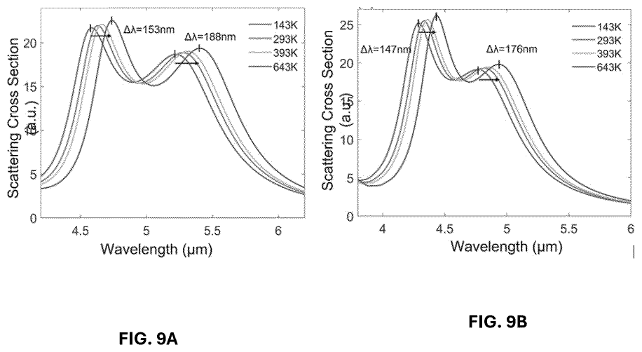

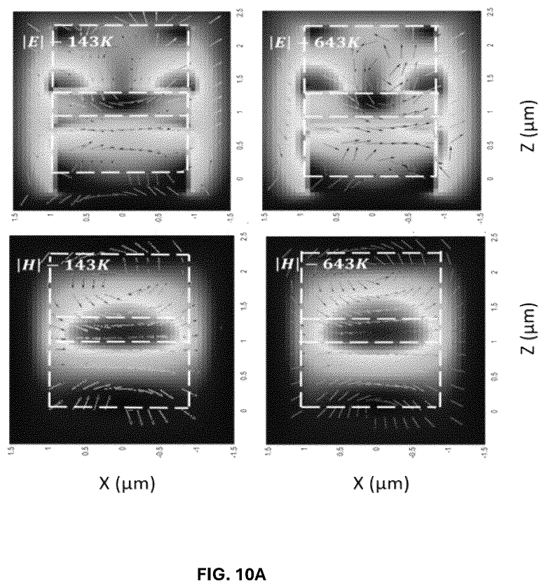

For comparison, uniform Si structures of identical sizes, exhibit significant temperature sensitivity leading to resonance wavelength shifts of up to 190 nm. This is illustrated in FIGS. 9A-9B showing spectra for uncompensated TO structures for cubic (FIG. 9A) and disk (FIG. 9B) geometries. The size (volume) of the resonators in both cases match the size (volume) of the corresponding resonators in FIGS. 8A-8D. In both cases of FIGS. 9A and 9B the spectra exhibit significant redshifts, manifesting undesirable temperature sensitive properties, as opposed to the temperature invariant hybrid structures presented in FIGS. 8A-8D.

Maximal sensitivity (Sₘₐₓ) for the fundamental mode in the cubic structure (circled in FIG. 8A), receives a value of |Smax|=0.0012, while |Smax|=0.0013 is obtained for the 2nd mode in the disk geometry (highlighted by a circle in FIG. 8C).

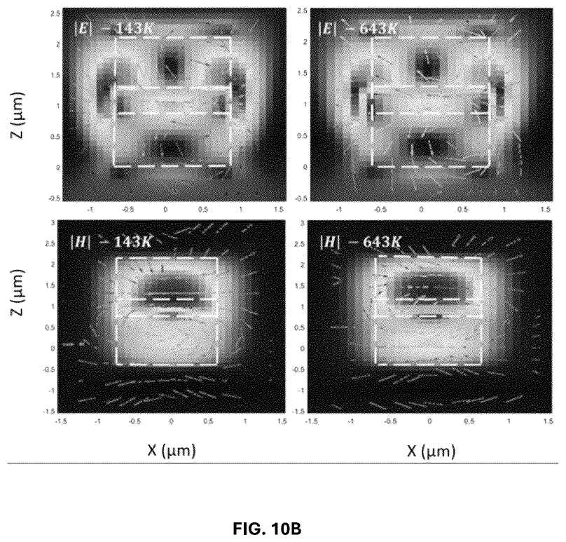

The field profiles for these structures were also calculated. In this connection, reference is made to FIGS. 10A and 10B which present the electric and magnetic field patterns of the cubic and disk structures at the fundamental MD resonance, at the lowest (143K) and highest (643K) temperatures. FIG. 10A shows the electric and magnetic field patterns (xz plane) of the cubic resonator at the first resonance λ=5.86 μm; the cubic geometry is: h_{Si}=0.92 μm, h_{PbTe}=0.34 μm, while the length and width at the x-y plane are 1 μm each. FIG. 10B shows the electric and magnetic field patterns (xz plane) of the disk resonator at the second resonance λ=4.71 μm. The disk geometry is h_{Si}=0.96 μm, h_{PbTe}=0.24 μm, r=0.5 μm.

Turning back to FIGS. 8B and 8D, both structures show minor variations in phase and amplitude between the two extreme temperatures (T=143K and T=643K). These variations are mostly observed around the abrupt changes at the resonance wavelengths and are slightly larger for the disk geometry.

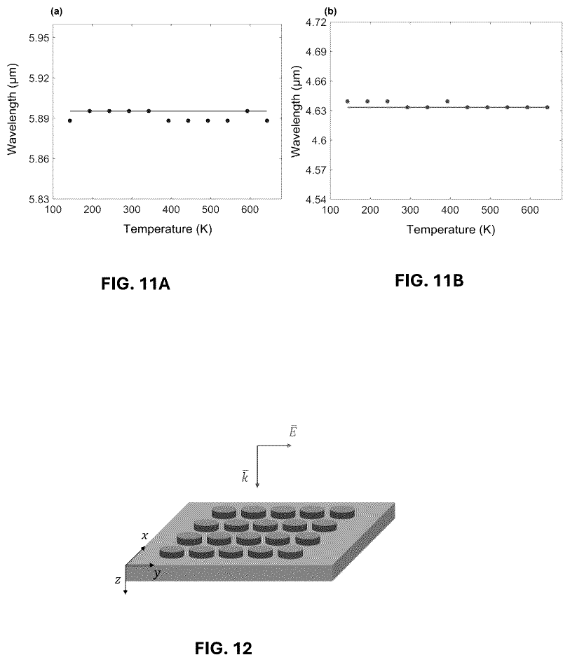

Reference is made to FIGS. 11A and 11B, which summarize the temperature dependent resonant wavelength properties of cubic and disk hybrid Mie resonators. The figures show extracted resonance wavelength vs. temperature for fundamental mode in the cubic resonator of FIG. 10A (FIG. 11A), the 2nd mode of the disk resonator of FIG. 10C (FIG. 11B).

Temperature independent response is manifested by near zero values of Smax (Sₘₐₓ≈0.0013) for both structures, demonstrating the ability to tailor the unit cell parameters in order to mitigate temperature effects per given mode.

Similar to the spherical resonator, complete elimination of the effective thermo-optic response can be achieved for a reduced temperature range of ΔT≈ 200K. This can be seen in FIG. 11B, where the disk resonator exhibits zero resonance wavelength shifts (dλ/dT=0), between T=443K and T=643K. Similarly, the parameter sweep process can be further optimized for any of light's degrees of freedom (e.g., phase, amplitude, polarization, angular momentum etc.).

Following the study of temperature invariant response in single meta-atoms, the inventors implemented full metasurface arrays. Such meta-optic components could be integrated into nanophotonic and electro-optic devices (filters, beam shaper, lenses, etc.) providing stable, robust and temperature independent response.

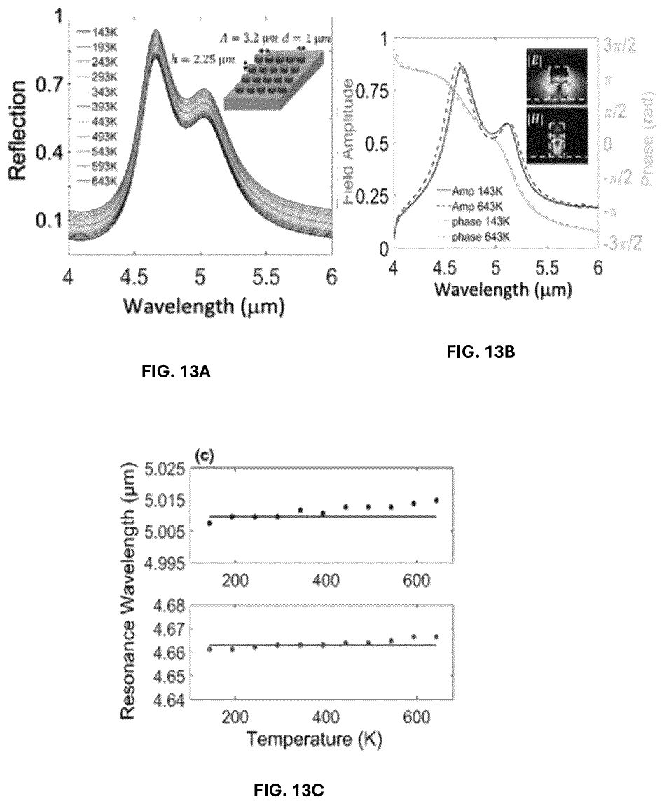

Reference is made to FIGS. 12 and 13A-13C. FIG. 12 shows the schematic of the simulated metasurface structure; and FIG. 13A-13C show the simulation procedure and results.

The inventors have performed simulations of cross section scattering and of the reflection and transmission metasurfaces. The simulations of cross section scattering were computed using the ‘cross-section’ analysis object. The simulation region consisted of each of the structures surrounded by air. A non-uniformal conformal mesh was used. A mesh size of at least 10× smaller than the minimum wavelength in the material was used with boundary conditions of perfectly matched layer. Simulations of reflection and transmission metasurfaces were computed using the ‘Grating S parameters’ analysis object. The simulation region consisted of a full metasurface comprised of each structure (including substate, whenever applies) surrounded by air. PML boundary conditions were used in the radiation axis \hat{z}, while periodic symmetric and antisymmetric boundary conditions were used in the \hat{x}, ŷ directions, respectively. The boundary conditions are selected with respect to the polarization direction and dictate the electric and magnetic field components which are zero at the plane of symmetry.

FIG. 13A presents FDTD calculated spectra for a metasurface comprised of hybrid disk resonator unit cells. BaF₂ was chosen as the substrate material, due to its low thermo-optic response (dn/dT≈−19·10−6[1/K]), low refractive index, as well as a wide transparency window in the visible to MIR range. The metasurface layout along with the lattice constant (Λ=3.2 μm) are shown in the inset of FIG. 13A. Since the periodicity of the structure is smaller than the free space wavelength of the incident light, the overall scattering properties are mostly inherited by the single unit cell resonator. For very small lattice constants, the inter-particle interactions would be more significant.

The inventors have demonstrated that the scattering cross section, amplitude, resonance wavelength, as well as the phase, for the two fundamental modes—all maintain their room temperature values (FIGS. 13A and 13B). Minor resonance wavelength shifts of Δλmax<5 nm are observed for the two resonant modes, as can be seen in FIG. 13C. The corresponding Smax values for the two fundamental modes are Smax=0.001 and Smax=7.72×10−4, for 143K<T<643K, respectively. Perfect temperature invariant performance (Δλ=0, Smax=0) is observed between T=293K and T=393K (lower panel in FIG. 13C), while maximum resonance shift as small as Δλ=0.9 nm, is obtained for a wider temperature range ΔT=250K (243K<T<493K). Turning back to FIG. 3, a similar uniform conventional-type Si metasurface with no TO correction would have exhibited a Δλ≈75 nm for the same temperature gradient ΔT=250K.

FIG. 13B presents the reflection phase, demonstrating temperature invariant full 2π phase coverage across the two fundamental modes. Electric and magnetic field profiles of the fundamental dipole mode are presented in the inset of FIG. 13B, exhibiting the typical field distribution of MD, similar to the field patterns of single disk resonators (as described above with reference to FIGS. 10A-10B).

Spanning 2π phase coverage is fundamental to meta-optic design as it allows to implement a plethora of optical functionalities. The capability to maintain temperature independent resonant wavelength along with 2π phase coverage in a realistic meta-optic device, demonstrates the strength of the metasurface structure of the present disclosure and the ability to implement TO dispersion in nanophotonic devices.

Thus, the technique of the present disclosure provides for eliminating thermally induced shifts in the optical properties of nanophotonic and meta-optic devices. This is achieved by utilizing meta-atom unit cells, configured as a hybrid unit cell composed from at least one pair of interfacing layers made of materials with opposite TO coefficients, respectively, allowing to obtain near zero effective TO coefficient (dneff/dT≈0). By optimizing the geometry of the hybrid unit-cell as described above, any spectral band can be covered in the transparency window of the materials (3.8 μm<λ<15.5 μm), by scaling the total size of the unit cell (while keeping the same volume ratio of the layers).

The inventors demonstrated temperature invariant response for multilayer Bragg mirrors and single meta-atoms of various geometries, and also demonstrated very small variations in the resonance frequency (Smax<0.001), amplitude and phase of these resonators, across large temperature gradients spanning 500K degrees. Thermally induced optical shifts are at least an order of magnitude smaller than the shifts of similar resonators with no TO shift correction.

The temperature invariant capabilities of full metasurface arrays surpass single resonators, due to the reduction in the scattering channels and increase in resonance quality factors. Hybrid disk metasurfaces exhibited near perfect temperature invariant response with resonance wavelength sensitivity of dλeff/dT≈5 pm/K, for the temperature range 143K<T<643K. Peak performance this for metasurface was achieved at Smax=7.72×10−4. For relaxed temperature gradient conditions of ΔT≈150K, the inventors achieved perfect zero effective thermo-optic response with Smax≈0, completely eliminating TO effects.

It should be noted that due to the in-plane symmetry in the resonator structures and the normal incident beam, the output response is polarization insensitive. However, for asymmetric resonators, unit-cell arrangements that break the in-plane symmetry, or more complex excitation conditions, TO compensation depends on the incident beam polarization. In these cases, polarization insensitive response might require more complex unit cells that provide extra degrees of freedom.

This all-dielectric (metal free) approach for temperature invariant configuration of single meta-atoms and meta-optics devices allows to compensate for, and optimize TO dispersions effecting resonance wavelength, amplitude and phase. The inventors have demonstrated that near perfect temperature invariant performance can be achieved for large temperature variations spanning 500K degrees, which would have otherwise significantly altered the optical properties of the device. Hence, the technique of the present disclosure, providing temperature invariant response of the metasurface structure, allows its use in various applications enhancing efficiency, stability, and performance of photonic devices.

1. An optical element for use in a photonic device, the optical element being configured and operable as a sub-wavelength resonator having predetermined optical properties defining an optical response to incident light, wherein the optical element is configured as a metal-free multi-material structure of predetermined geometry and dimensions in which each two interfacing materials have positive and negative thermo-optic coefficients, respectively, such that the optical element has a near-zero effective thermo-optic coefficient, thereby providing substantial temperature invariance of said optical properties in predetermined wavelength and temperature ranges.

2. The optical element according to claim 1, wherein a temperature range of the near-zero effective thermo-optic coefficient is from 0 K up to a temperature corresponding to at least one of the following: a lowest melting temperature of the material of at least one of said two interfacing materials; lowest temperature of phase transition of the at least one of said two interfacing materials; a lowest temperature at which material properties of at least one of said two interfacing materials are no longer capable of supporting the optical response.

3. The optical element according to claim 1, wherein said predetermined temperature range is about 500K.

4. The optical element according to claim 1, wherein the geometry and dimensions of the multi-material structure are selected such that scattering properties of the optical element within said predetermined wavelength range substantially overlap.

5. The optical element according to claim 1, wherein a negative thermo-optic coefficient material of the two interfacing materials is a material from a lead chalcogenide family PbX, wherein X is any one of the following: Te, Se, S.

6. The optical element according to claim 1, configured as a multi-layer structure.

7. The optical element according to claim 1, configured as a core-shell spherical Mie resonator.

8. The optical element according to claim 7, wherein said core-shell spherical Mie resonator is a three-layer core-shell Si/PbTe/Si spherical structure.

9. The optical element according to claim 8, wherein a thickness of a PbTe inner shell is selected to provide substantial overlap of scattering properties of the resonator within said predetermined wavelength and temperature ranges.

10. The optical element according to claim 9, wherein said predetermined temperature range is about 143K-643K.

11. The optical element according to claim 1, configured as a cubic resonator, said predetermined dimensions comprising a side length of a cube and a thickness of each material of the multi-material structure of the cubic resonator.

12. The optical element according to claim 6, configured as a cubic resonator, said predetermined dimensions comprising a side length of a cube and a height of each of layers of the multi-layer structure of the cubic resonator.

13. The optical element according to claim 12, wherein said cubic resonator is configured as a cubic three-layer hybrid resonator comprising bottom and top layers made of Si, and a middle layer made of PbTe.

14. The optical element according to claim 1, configured as a disk resonator, said predetermined dimensions comprising a disk diameter and a thickness of each material of the multi-material structure of the disk resonator

15. The optical element according to claim 6, configured as a disk resonator, said predetermined dimensions comprising a disk diameter and a height of each layer of the multi-layer structure of the disk resonator.

16. The optical element according to claim 15, wherein said disk resonator is configured as a disk three-layer hybrid resonator comprising bottom and top layers made of Si, and a middle layer made of PbTe.

17. The optical element according to claim 1, wherein said temperature invariant optical properties comprise one or more of the following characteristics of light resulting from interaction with the incident light: wavelength of Mie resonant mode, cross section, amplitude, phase response, polarization, angular momentum, orbital angular momentum.

18. The optical element according to claim 1, configured for transmission of incident light.

19. The optical element according to claim 1, configured for reflection or scattering of incident light.

20. A metasurface structure for a photonic device, the metasurface structure comprising a plurality of unit cells, wherein each unit cell is configured as the optical element of claim 1, thereby providing substantial temperature invariance of optical properties of the metasurface structure in predetermined wavelength and temperature ranges.

21. The metamaterial structure according to claim 20, wherein geometry, dimensions of the unit cells, and relative orientation and distance between the unit cells are selected to optimize the temperature invariance of the optical properties.

22. A metasurface structure for a photonic device, wherein the metasurface structure comprises an array of spaced-apart individual unit cells operable as subwavelength resonators having predetermined optical properties, wherein:
each of the unit cells is configured as a metal-free multi-material structure of predetermined geometry and dimensions in which each two interfacing materials have positive and negative thermo-optic coefficients, respectively, such that the unit cell has a near-zero effective thermo-optic coefficient.

23. The metasurface structure according to claim 22, wherein the unit cells of the array are arranged in M sets (M≥2) of similar arrangements, each formed by K unit cells (K≥2), wherein the unit cells of the set are similar or different in at least one of geometry, dimensions and orientation of the unit cell.

24. A photonic device comprising one or more optical elements, each configured as the optical element of claim 1.

25. A photonic device comprising the metasurface structure configured according to claim 22.
